(19) United States
(12) Patent Application Publication
(10) Pub. No.: US 2025/0236244 A1
(43) Pub. Date: Jul. 24, 2025

(54) Protective Case Configured to Protect via Flexural Bending of Layers

(71) Applicant: Rohan Vishnubhai Patel, Bensalem, PA (US)

(72) Inventor: Rohan Vishnubhai Patel, Bensalem, PA (US)

(21) Appl. No.: 19/170,313

(22) Filed: Apr. 4, 2025

Related U.S. Application Data
(63) Continuation of application No. 16/910,460, filed on Jun. 24, 2020, now Pat. No. 11,673,516.
(60) Provisional application No. 63/572,384, filed on Apr. 9, 2024.

(51) Int. Cl. B60R 13/10

(52) U.S. Cl. CPC B60R 13/105

(57) ABSTRACT

A protective phone case is disclosed, comprising at least one inner layer and at least one outer layer, wherein the layers are separated by one or more gaps configured to absorb shock through controlled bending and sliding rather than material compression. The inner layer, composed of semi-rigid or rigid material, deforms temporarily into the gap upon impact, reducing transmitted forces. Variations include wavy or undulating structures in the inner layer, multi-piece or multi-layer configurations, and structures that allow flattening and frictional dissipation. The case may incorporate acoustic tunnels to redirect speaker output and structural lips to protect camera lenses. The protective design offers greater rigidity and thinner construction than conventional cases, allowing reduced size and weight while preserving or enhancing shock absorption.

This non-provisional patent application claims the benefit of provisional application 63/572,384, filed on Apr. 9, 2024.

### TECHNICAL FIELD

The present invention relates to a protective phone case, specifically designed to absorb shock and protect an electronic device using structural elements such as double-layered walls, air gaps, wavy structures, and semi-rigid or rigid materials.

### SUMMARY OF THE INVENTION

The invention provides a protective case for a portable object, featuring an inner and outer layer separated by at least one gap. The inner layer, made from a semi-rigid material, bends temporarily into the gap under impact, absorbing shock and reducing damage to the enclosed object. In some embodiments, the inner layer protrudes to form a squeezable space, or includes a wavy structure that flattens and dissipates energy through deformation and friction. The invention applies to various devices, including phones, key fobs, smartwatches, tablets, VR headsets, and wearable protective gear, and may be manufactured using 3D printing from digital models.

### BRIEF DESCRIPTION OF THE DRAWINGS

FIG. 1: General structure of the protective phone case.

FIGS. 2-3: Cross-sectional view showing a cavity between inner and outer layers for shock absorption via flexural bending. Includes base surface, edge surface, protruding lip, and intermediate cavity.

FIG. 4: Variant with a cut in the inner edge surface to enhance flexibility while maintaining device stability.

FIG. 5: Cross-section with improved corner geometry for optimized shock absorption.

FIG. 6: Alternative design using semi-rigid or rigid materials with hollow walls to resist impact.

FIG. 7: Two-piece design with unattached or fused components; inner wavy layer provides spring-like absorption.

FIG. 8: Variation of FIG. 3 with cavity partially filled by material of same or different density.

FIGS. 9-10: Variations of FIG. 7 showing different extensions of the lip and base surface.

FIG. 11: Three-piece design with smooth inner and outer layers and a wavy intermediate layer for enhanced absorption.

FIGS. 12-18: Configurations showing dynamic wavy layers that adapt to distribute impact forces.

FIG. 19: Cross-section of a sound channel that redirects speaker output toward the user or screen.

FIG. 20: Cross-section showing a protective lens lip extending at least 0.5 mm over the edge of the lens glass.

FIGS. 21-22: Cross-sections showing a gap between the outer layer and the enclosed device.

FIG. 23: Embodiment combining elements of FIGS. 7 and 8.

FIG. 24: Case design with an elevated secondary outer layer to protect raised surfaces like a camera module.

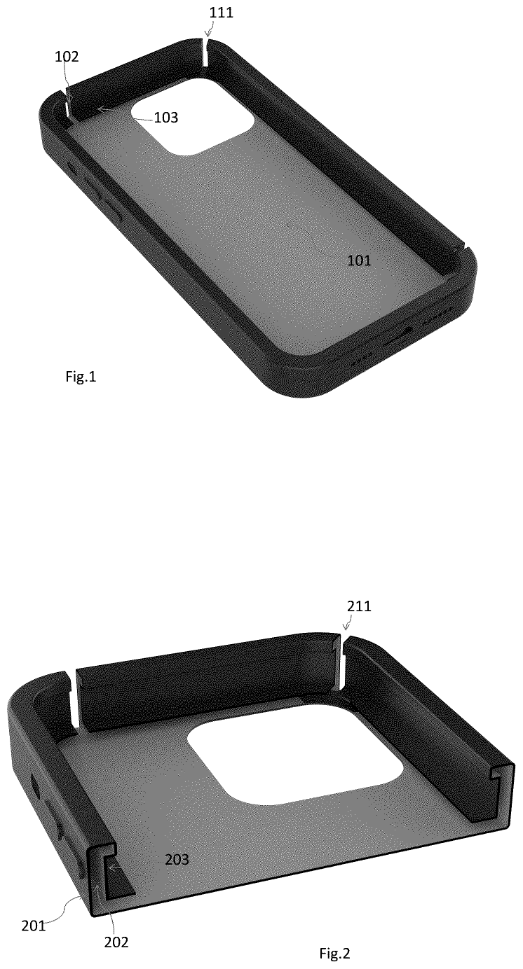

### DETAILED DESCRIPTION OF THE INVENTION

A portion or all of at least one inner layer is made of a semi-rigid or rigid material with a flexural strength ideally ranging from 12-17 MPa, 17-29 MPa, or greater than 29 MPa. This value may vary based on the structure and thickness of the layer. The inner layer is configured to dynamically adjust, bend, or momentarily flatten to absorb shock. A softer version may use material with a flexural strength of 7-12 MPa, while premium versions may use material with a flexural strength of 27-47 MPa, 47-97 MPa, or higher.

Similarly, a portion or all of at least one outer layer is composed of a semi-rigid or rigid material with a flexural strength ideally in the range of 12-17 MPa, 17-29 MPa, or greater than 29 MPa. This can also vary based on the structure and thickness. The outer layer may bend or momentarily flatten under impact. Softer versions may range from 7-12 MPa, while premium configurations may include outer layers with flexural strength from 27-47 MPa, 47-97 MPa, or above.

As shown in Embodiment 100, the protective case includes an outer layer (101) that protects the bottom of the electronic device. A secondary layer (103) protrudes from the outer layer, adding reinforcement and potentially improving grip. To ease insertion and removal of the device, at least one slit (111) may be positioned at one or more corners. The case may include a single slit or multiple slits in one, two, three, or all four corners.

In FIG. 2, the outer layer is labeled 201, the inner layer 203, and the gap between them 202. At least one slit is labeled 211, with two slits illustrated in this embodiment. These slits enhance flexibility to allow device insertion and removal without compromising structural integrity.

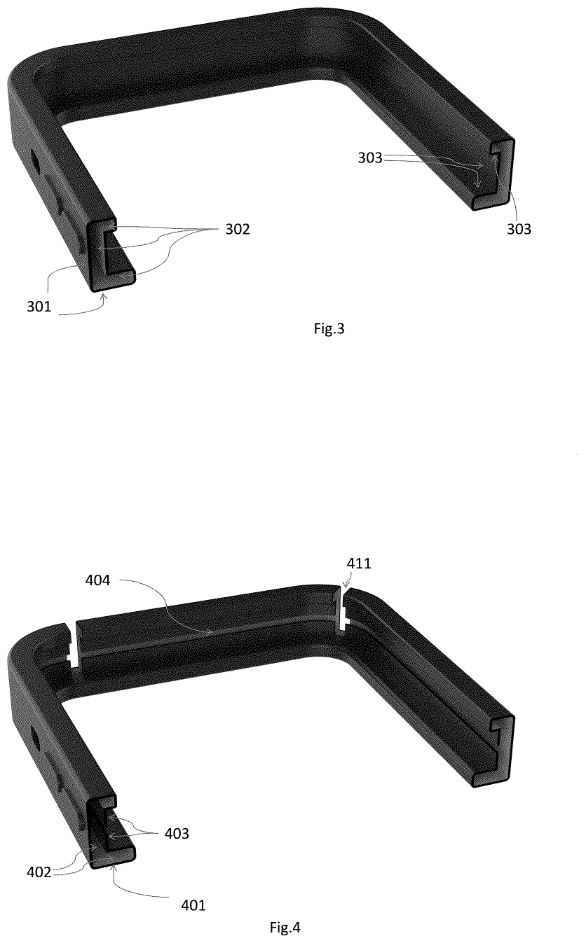

The embodiment illustrated in FIG. 3 features an outer layer designated as 301, an inner layer designated as 303, and a space or gap between the outer and inner layers designated as 302. The first arrow, positioned at the top of region 302, indicates the space between the inner layer of the flap and the outer layer of the flap. The central arrow pointing to region 302 illustrates the gap between the outer layer 301 and the inner layer 303 in the edge area, where the edge area refers to the four sides and corners of the electronic device positioned between the top surface and the bottom surface, with the top surface generally comprising the display. The third arrow, located at the bottom and also pointing to region 302, identifies the gap between the outer layer of the base and the inner layer of the base, which serves to protect the bottom surface of the electronic device.

The embodiment depicted in FIG. 4 includes an outer layer designated as 401 and an inner layer designated as 403. The gap between the inner and outer layers is identified as 402. A slit that facilitates easy installation and removal of the electronic device is marked as 411. Additionally, a horizontal slit located within the inner layer 403 is designated as 404, extending laterally across the structure. The horizontal slit 404 enhances flexibility, which may be desirable depending on the intended design characteristics of the case. In certain embodiments, the horizontal slit 404 also enables post-manufacturing processes, such as the removal of soluble materials used during fabrication.

The embodiment illustrated in FIG. 5 features an outer layer designated as 501 at the base of the protective case. The outer layer 501 is also present along the middle section, designated as edge section, and continues to the top portion, where it is identified by a top arrow indicating its coverage around the top surface of the electronic device. In this region, the outer layer 501 provides protection to the area surrounding the display. The outer layer then transitions and forms the inner layer at the top, designated as 503. This inner layer 503 extends from the top flap area, down through the edge area, and continues to the bottom area of the electronic device. The gap between the inner layer 503 and the electronic device, which facilitates cushioning and secure fitting, is designated as 505. The gap between the inner layer 503 and the outer layer 501 is designated as 502. The electronic device itself is designated as 512.

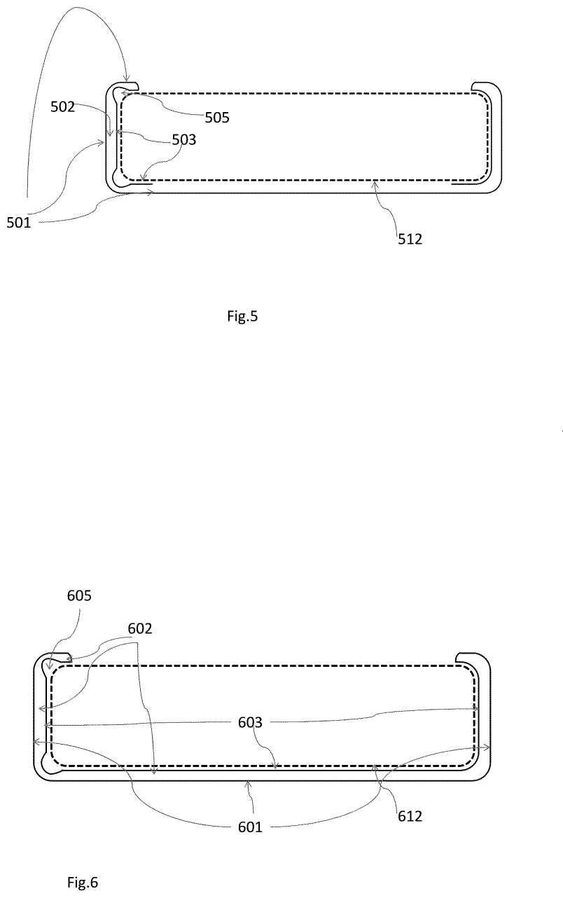

FIG. 6 illustrates a cross-sectional view of a protective phone case positioned on a mobile phone (612). The case includes an outer layer (601), which serves as the primary structural component providing external protection. An inner layer (603) is located adjacent to the electronic device, forming the interface between the case and the phone. Between the outer layer (601) and the inner layer (603) is a gap (602), which acts as a cushioning zone to absorb shock or distribute impact forces. Additionally, another gap (605) is present between the inner layer (603) and the surface of the electronic device (612), providing room for shock absorption, airflow, or mechanical tolerance within the interior of the case.

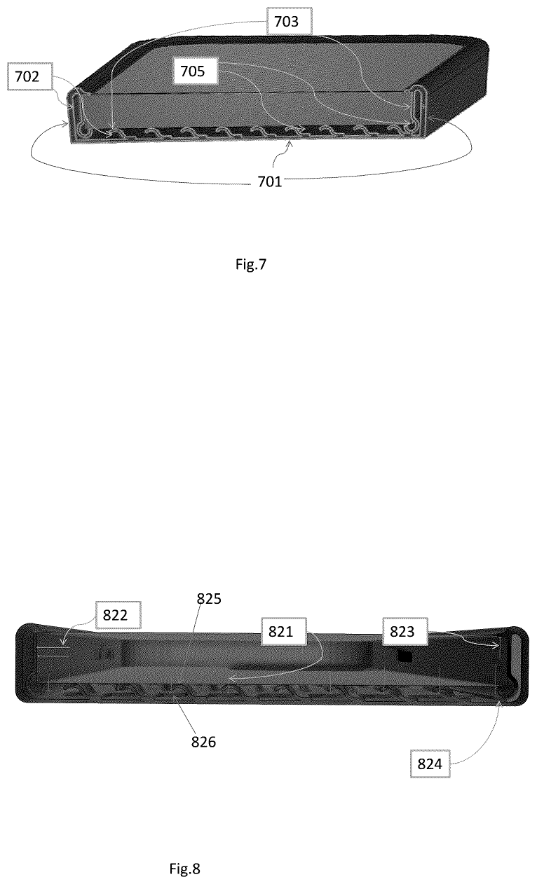

FIG. 7 illustrates a cross-sectional view of a phone case according to another embodiment. The case includes an outer layer 701, which serves as the primary structural and impact-resistant shell. Protruding inward from the outer layer 701 is at least one inner layer 703, which extends toward the electronic device. A gap 702 is defined between the inner layer 703 and the outer layer 701, which may be filled with air or another material to enhance shock absorption. Additionally, at least one other gap 705 is present between the inner layer 703 and the surface of the cell phone device, providing further isolation and protection by accommodating shock, dimensional tolerances, or airflow between the case and the device.

FIG. 8 illustrates various stresses that may be experienced by the inner layer of a phone case depending on the angle at which the phone is dropped. In FIG. 821, the phone case is shown in an orientation where the force of impact is directed vertically downward, as indicated by the downward-pointing arrow. In this scenario, the inner layer 825, which is at least one inner layer disposed within the case, is compressed upon impact and deformed, as illustrated by the compressed configuration labeled 826. FIG. 822 depicts a drop impact where the force is applied FIG. 9 illustrates cross-sectional view of bumper case with electronics device within, which illustrates 904 as gap, 906 as outer layer, 905 as at least one inner layer that protrudes from outer layer 906. 901 shows forces inner layer may experience when dropped sideways on side one of the four sides between display and bottom layer. 902 illustrate force with red arrow when phone is dropped downward with display upward on ground. 903 illustrate force's direction on at least one lip surrounding to the display when phone drops upside down with display facing downward.

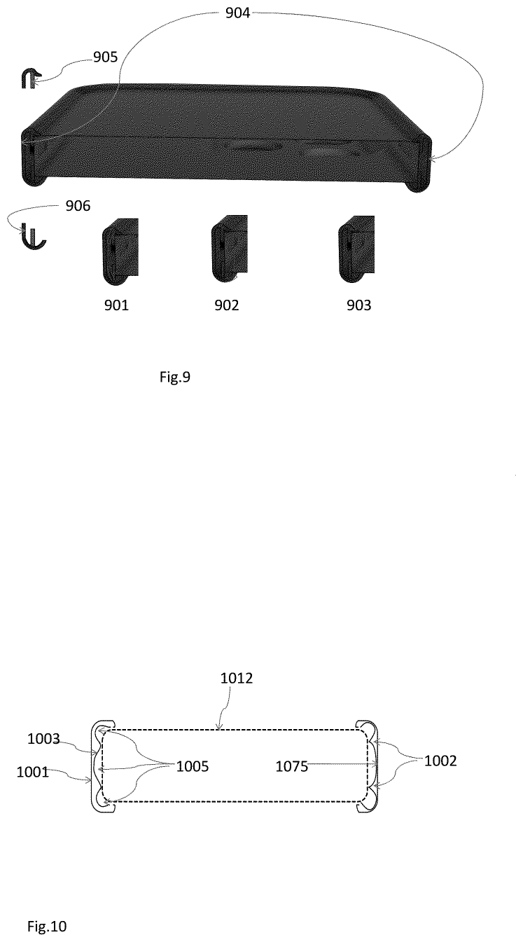

FIG. 10 illustrates cross-sectional view of two-piece bumper case design with electronics device within marked as 1012. Outer layer of protective case marked as 1001. Inner layer, second piece of two-piece design marked as 1003. Gap between outer layer and inner layer marked as 1002. Gap between electronic device and inner layer marked as 1005. During a drop, the inner and the outer layer both goes under flexural strength, bends, and absorb shocks, and soften the shock to the device within. In modified embodiment, the outer layer 1001 and the inner layer 1002 can be fused or glued or secured together directly or through an another medium in between. In FIG. 10, the outer layer 1001 and the inner layer are marked 1075 where they can be connected to provide specific purpose or type of shock protection. The inner layer and the outer layer can also be connected by having a softer material in at least one gap between them fusing both to one another.

FIG. 11 illustrates slightly different embodiment of FIG. 10. In this figure, the outer layer 1001 does not protrude all the way touching the electronic device on its edges, but starts and ends on outer layer 1103. The inner layer is marked as 1103. The gap between inner layer and outer layer is marked as 1102. The gap between inner layer and electronic device 1112 is marked as 1105. The gap between inner layer 1103 and electronic device 1112 is marked as 1105. Both the inner layer and the outer layer can be fused with one another directly or indirectly as marked as 1175 and/or at any other point. The inner layer and the outer layer can also be connected by having a softer material in at least one gap between them fusing both to one another.

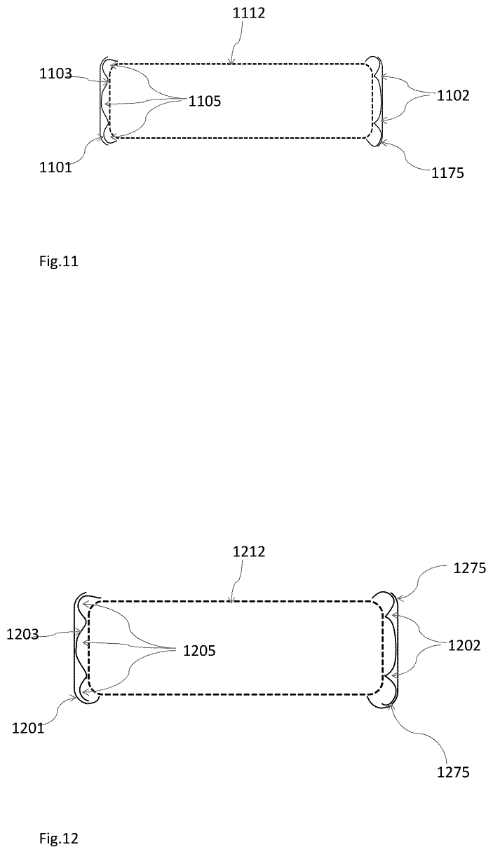

FIG. 12 illustrates slightly different embodiment of FIGS. 11 and 10. In this one, the inner layer 1203 starts from touching the electronic device 1212 on top, but ends without touching on bottom layer of the bottom surface of the electronic device. In contrast, the outer layer 1201 starts from bottom touching the electronic device surface on bottom, and ends without touching the top surface of electronic device. And it ends on inner layer at the top. Both the inner layer and the outer layer can be fused with one another directly or indirectly as marked as 1275 and/or at any other point. The inner layer and the outer layer can also be connected by having a softer material in at least one gap between them fusing both to one another.

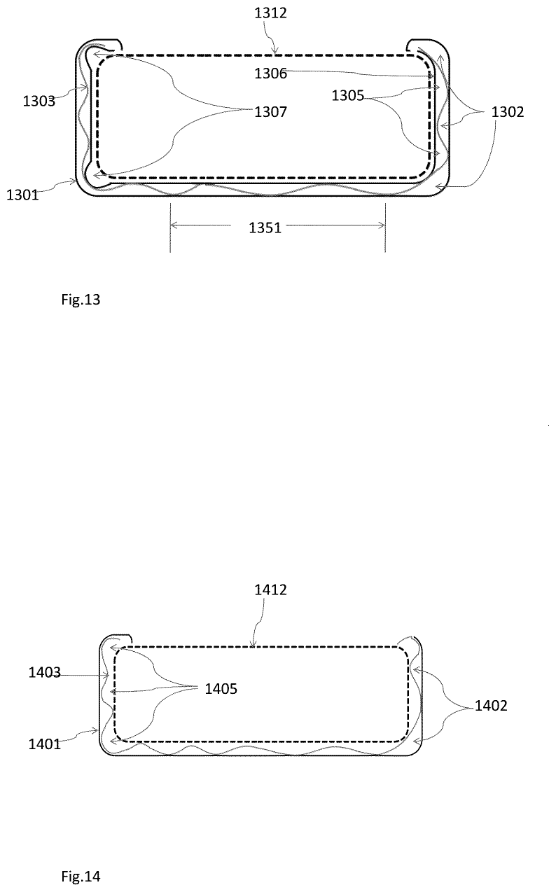

FIG. 13 illustrates a full-case protective design configured to provide substantial coverage to all four sides and the bottom layer of the electronic device 1312. In this embodiment, the outermost layer of the case is marked as 1301, forming the rigid structural boundary. The first inner layer, marked as 1303, is positioned within the outer layer, while a secondary inner layer, marked as 1306, is situated between the first inner layer and the electronic device. A gap 1302 is defined between the outer layer 1301 and the first inner layer 1303, and a second gap 1305 is located between the first inner layer 1303 and the secondary inner layer 1306. An additional gap 1307 is defined between the secondary inner layer 1306 and the surface of the electronic device 1312, allowing for isolated movement and energy dissipation. Notably, the first inner layer 1303 features a wavy or undulating structure along the bottom region of the case. The distance between two adjacent bottom peaks of this wavy structure is marked as 13151, while the actual length of the wavy layer measured along its curvature between the vertical lines marked as 1351 exceeds the straight-line distance between those points. This excess length allows the wavy layer to undergo a flattening deformation when subjected to bending stress during a drop impact. As the structure flattens, the wavy portion compresses and slides laterally within the space defined between the outer layer 1301 and the secondary inner layer 1306. This lateral motion introduces frictional resistance between the contacting surfaces, which contributes to the dissipation of impact energy. Accordingly, the wavy configuration not only softens the shock transferred to the electronic device 1312 through geometric deformation but also absorbs additional energy through friction generated during the sideways sliding of the flattened inner layer. Both the inner layer and the outer layer can be fused with one another directly or indirectly at any point. The inner layer and the outer layer can also be connected by having a softer material in at least one gap between them fusing both to one another. Both the first inner layer and the second inner layer can be fused with one another directly or indirectly at any point. The first inner layer and the second inner layer can also be connected by having a softer material in at least one gap between them fusing both to one another. Two or more of the outer layer, the first inner layer and the second layer can be fused with one another directly or indirectly at any point. They can also be connected by having a softer material in at least one gap between them fusing both to one another.

FIG. 14 shows another embodiment where configuration has only outer layer marked as 1401 and inner layer marked as 1403. Inner layer 1403 is wavy shaped creating gap between inner layer and outer layer marked as 1402 and gap between inner layer and electronic device 1412 marked as 1405. Inner layer 1403 flattens and slides between electronic device and outer layer during drop and absorbs energy from resistance during sliding and bending of inner layer. It softens the shock transferred to electronic device within. Both the inner layer and the outer layer can be fused with one another directly or indirectly at any point. The inner layer and the outer layer can also be connected by having a softer material in at least one gap between them fusing both to one another.

FIG. 15 illustrates an embodiment in which a wavy inner layer is positioned around the perimeter of the electronic device, which is indicated by a dashed outline. The inner layer forms a continuous or semi-continuous wavy structure that surrounds the device, contributing to shock absorption during impact. The wavy structure is defined by a thickness W, which represents the effective vertical dimension of the wave peaks relative to the base surface. The material thickness of the wavy layer itself is marked as S. In this configuration, W, the total thickness created by the wavy geometry, is greater than 1.5 times the thickness of the rigid surface or base layer to which the structure is attached. This dimensional relationship allows the wavy inner layer to compress and flatten under mechanical stress during a drop, absorbing energy through geometric deformation. As the wave pattern flattens, it dissipates impact forces and softens the shock transmitted to the electronic device enclosed within, thereby enhancing protective performance.

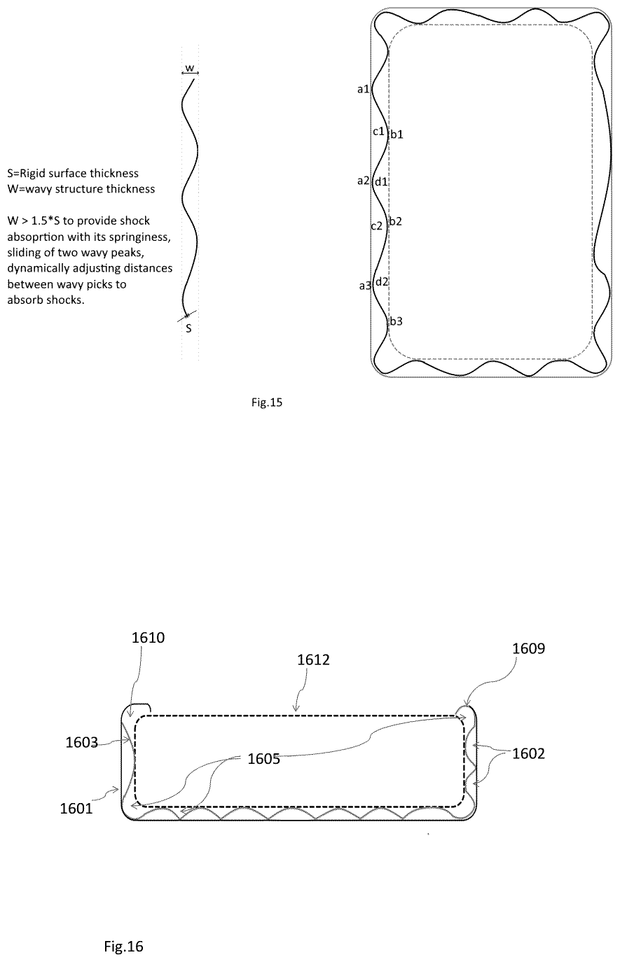

FIG. 16 illustrates another slightly different embodiment compared to the configuration shown in FIG. 14, with the wavy structure of the inner layer 1603 designed in a modified form to introduce additional structural and protective features. The inner layer 1603 may take on various configurations that result in different geometric air gaps between the inner layer and the outer layer or between the inner layer and the electronic device. In this embodiment, the outer layer is marked as 1601, while the inner layer is marked as 1603. A gap 1602 is defined between the inner layer and the outer layer, allowing for displacement and shock absorption during impact. The inner layer 1603 is also spaced from the electronic device, defining a gap 1605 which provides a cushioning buffer. A larger cavity, gap 1610, may be formed between the outer layer 1601 and the electronic device to enhance spatial isolation. Additionally, a gap 1609 is located at the corner region surrounding the top surface of the electronic device. In this region, the inner layer extends to form a lip structure, also marked as 1609, which projects upward to surround and protect the edge of the display area. This lip serves as an impact barrier during face-down drops, preventing direct contact between the display surface and the ground. The variations in the wavy inner layer geometry and the resulting air gaps contribute to a multi-directional energy-dissipation mechanism that enhances overall drop protection for the electronic device.

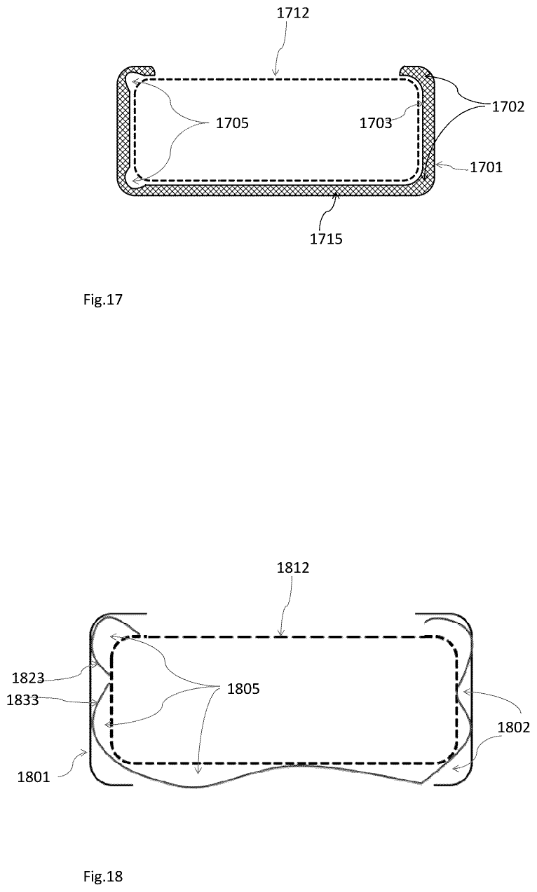

FIG. 17 illustrates an embodiment of a protective case design incorporating a multi-layer structure for enhanced impact absorption. In this configuration, the inner layer is marked as 1703, and the outer layer is marked as 1701. Positioned between the inner and outer layers are at least two middle layers, collectively marked as 1702. These middle layers may be composed of the same or different materials and are configured to introduce multiple interfaces and deformable zones within the case structure. A gap 1705 is defined between the inner layer 1703 and the electronic device 1712, providing an isolation space that reduces direct force transmission. The middle layers 1702 are further characterized by air gaps between themselves and adjacent layers-whether outer, inner, or between one another. These gaps serve as buffer zones that compress or collapse upon impact when the device is dropped. As the case experiences external force, the layered structure allows for staged deformation, where the middle layers compress and the enclosed gaps are squeezed, thereby absorbing and dissipating energy through both material compression and displacement. This layered configuration softens the shock transferred to the electronic device 1712, reducing the likelihood of internal damage.

FIG. 18 illustrates an embodiment of a protective case design that features a multi-piece inner layer structure for enhanced adaptability and shock absorption. In this configuration, the outermost structural shell is marked as 1801 and serves as the primary impact-resistant outer layer. The inner layer is divided into at least two separate components: a top inner layer piece marked as 1823 and a bottom inner layer piece marked as 1833. These inner layer segments are positioned in such a way that they interface with distinct regions of the electronic device 1812. A gap 1802 is defined between either or both of the inner layer pieces (1823 and 1833) and the outer layer 1801, forming a deformable space to accommodate material displacement under impact. Additionally, a gap 1805 is defined between the top and/or bottom inner layer segments and the electronic device 1812, providing clearance that allows the inner layer to flex, compress, or slide under shock, thereby softening the impact transmitted to the device. The use of multiple inner layer segments enables the design to manage directional forces more efficiently and target specific areas of the device with varied structural responses depending on the angle and location of impact.

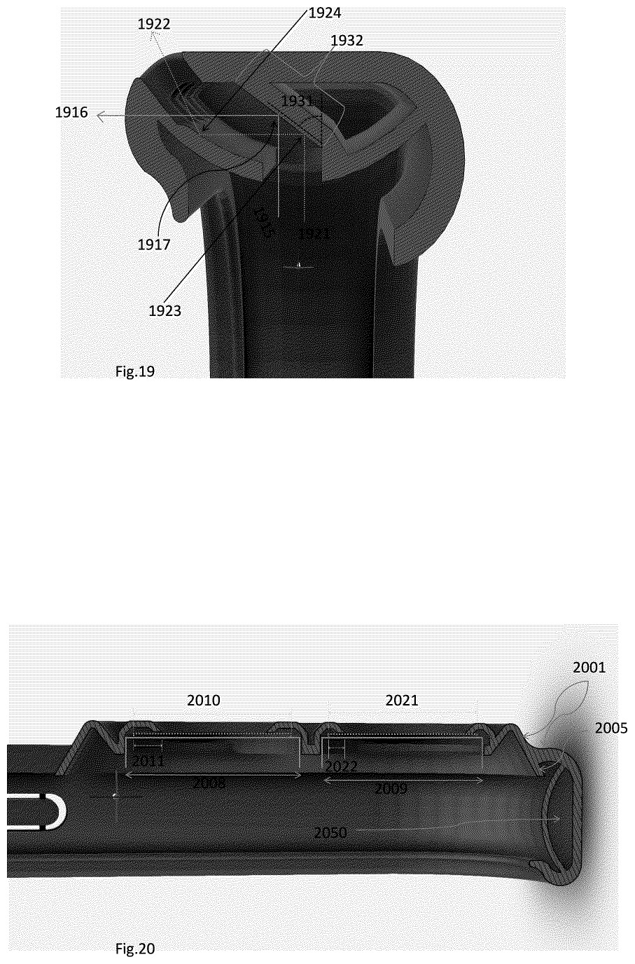

FIG. 19 illustrates a cross-sectional view of a sound-bending tunnel integrated within a protective case, configured to redirect audio output from a device's loudspeaker in a manner that enhances sound projection toward the user. Sound propagation is depicted through two representative sound paths, marked as 1916 and 1922. In the first path, audio exits the speaker and travels along trajectory 1916, where it encounters a sloped or angled deflector surface. Upon impact, the sound wave is redirected outward through a tunnel or aperture formed within the case structure, following the continuation of arrow 1916. In the second path, indicated by arrow 1922, sound exits the speaker and strikes a primary deflector surface at angle 1923. The wave is then redirected toward a secondary inner deflector surface, which in turn reflects the wave at angle 1924, directing it outward along the intended path. Reference numeral 1932 indicates a structural layer or surface positioned at an angle ranging between approximately 10 degrees to 80 degrees relative to the sound wave exiting the speaker. This angular configuration is selected based on the geometry of the case and the desired redirection path, enabling precise tuning of the sound projection direction. In one embodiment, the angle of surface 1932 may be between 35 degrees to 50 degrees, configured to redirect the sound wave at an angle of approximately 70 to 100 degrees relative to the original direction of sound emission from the speaker. This arrangement allows the redirected audio to be aimed more directly toward the user, enhancing acoustic performance. The first deflection angle, marked as 1931, may be varied based on the desired direction of final sound emission. Similarly, the secondary deflection angle, marked as 1924, may be tuned to optimize acoustic redirection based on the case geometry and the intended listening direction. This acoustic tunnel is designed to alter the speaker's natural sound trajectory—typically directed sideways or downward—and instead bend it toward the user, thereby improving perceived audio clarity and loudness. This design enhances the user experience while maintaining protective coverage of the speaker port, avoiding direct exposure to environmental impact. The embodiment shown in FIG. 19 may be used independently or in combination with one or more other embodiments or features previously described in connection with the protective case. The sound tunnel illustrated may be formed through a combination of multiple separate layers, collectively configured to redirect sound in a different direction. FIG. 20 illustrates a protective case design featuring extended structural coverage over the camera lenses of an electronic device. The protective layer extends inward from the outer perimeter of each lens glass, partially overlapping the surface to form an overhanging edge that shields high-contact regions while leaving the central optical area unobstructed. This configuration minimizes scratches and surface degradation, enhancing optical clarity and prolonging lens life.

Reference numerals 2010 and 2021 denote the glass widths of the first and second lenses, respectively. The protective layer overlaps these by distances 2011 and 2022, which may be at least 0.5 mm, 1.0 mm, 1.5 mm, or more. Frame widths are indicated by 2008 and 2009. These values can be varied across different lenses on the same device to create a buffer zone that absorbs external pressure and prevents direct surface contact.

Reference numeral 2005 indicates an inner layer protruding from the outer layer 2001, forming at least one gap 2050 between them. This gap may be empty or partially/fully filled with a material of different density or flexural strength. The camera protection structure may be formed on the inner layer, the outer layer, or an additional layer in a multi-piece case design. The protective layer may also include a transparent element over the central lens region or leave it open, depending on optical requirements. This structure may be used alone or combined with other protective features described elsewhere in this disclosure.

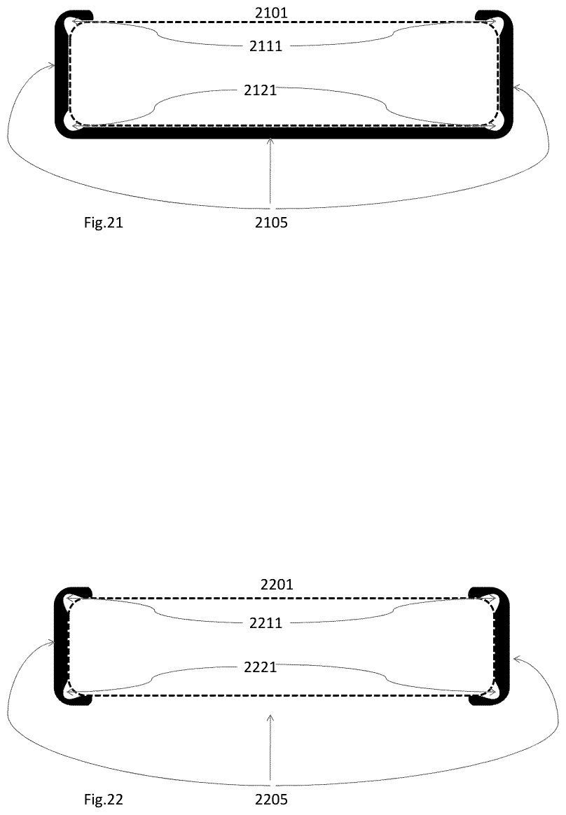

FIG. 21 illustrates an electronic device 2101 enclosed within a protective case comprising at least one outer layer 2105, which covers the four sides, four corners, and the bottom surface of the electronic device 2101. The protective case is configured to form at least one gap 2111 between the outer layer 2105 and the edge surrounding the display surface on the top of the device. Additionally, the protective case defines at least one gap 2121 between the outer layer 2105 and the edge surrounding the bottom surface of the electronic device 2101. The at least one gap 2111 and 2121 provides space for the outer layer 2105 bend and slide the electronic device 2101 to slide in the space.

FIG. 22 illustrates an electronic device 2201 enclosed within a protective case comprising at least one outer layer 2205 that is an opening on bottom surface, which covers the four sides, four corners, and the bottom surface of the electronic device 2101. The protective case is configured to form at least one gap 2211 between the outer layer 2205 and the edge surrounding the display surface on the top of the device. Additionally, the protective case defines at least one gap 2221 between the outer layer 2105 and the edge surrounding the bottom surface of the electronic device 2201. The at least one gap 2211 and 2221 provides space for the outer layer 2205 bend and slide the electronic device 2201 to slide in the space.

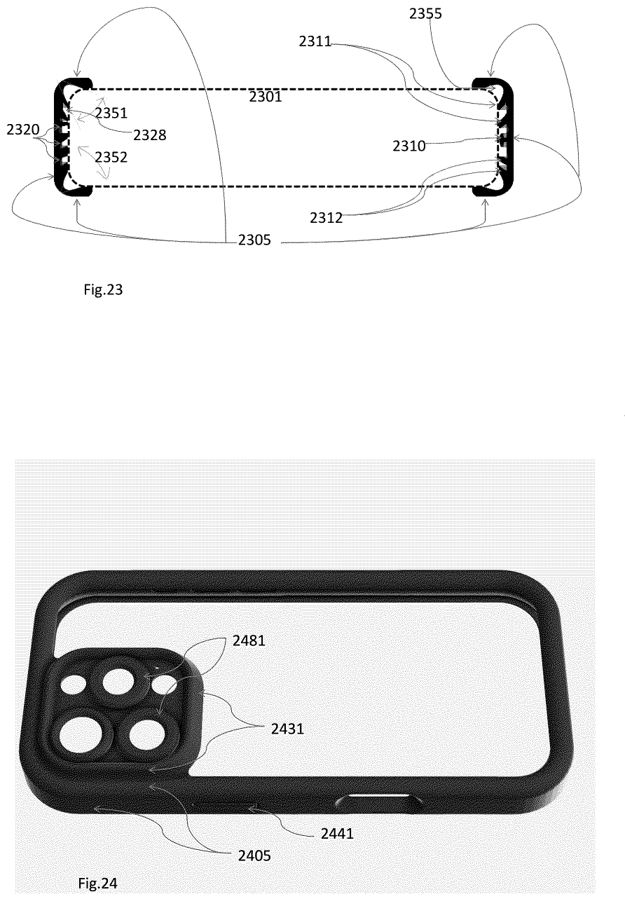

FIG. 23 illustrates an electronic device 2301, at least one outer layer 2305, at least one inner layer 2310, 2311, and 2312, and a thickness variation 2320 of the outer layer 2305. As shown in FIG. 23, the inner layers marked as 2312 in this illustration have a first gap marked in orange between the inner layers 2312 and the outer layer 2305, wherein the gap in this configuration is located above the inner layer 2312. A second gap, also marked in orange, is present between the inner layers 2311 and the outer layer 2305, wherein the gap in this configuration is located below the inner layers 2311. A third pair of gaps, marked in orange, is present between the inner layers 2310 and the outer layer 2305, wherein the first of the pair of gaps in this configuration is located above the inner layer 2310, and the second of the pair is located below the inner layer 2310. The inner layer must have an overhang that creates a void horizontally, vertically, in depth, or in any other direction that provides space for the inner layer to bend and compress to absorb shock during a drop and soften the impact for the electronic device. Another gap is marked as 2351 between the outer layer 2305 and the electronic device, which provides space for the outer layer to bend and allows the electronic device 2301 to move at least partially into that gap during a drop at certain angles. During this movement, the angle of the inner surfaces marked as 2351 increases momentarily to provide additional space for the electronic device within that gap. Another gap is marked as 2352 between the outer layer 2305 and the electronic device, which also provides space for the outer layer to bend and allows the electronic device 2301 to move at least partially into that gap during a drop at certain angles. During this movement, the angle of the inner surfaces marked as 2352 increases momentarily to provide additional space for the electronic device within that gap. The gaps, in combination with the variation in thickness of the at least one outer layer 2305 marked as 2320, can also be implemented to provide enhanced protection. Reference numeral 2328 indicates at least one gap between the inner layer and the electronic device enclosed within. This gap provides the necessary space for the electronic device to shift during impact and allows the inner layer to flex and deform, thereby absorbing shock. Reference numeral 2355 represents an additional gap located between the outer layer and the electronic device within.

FIG. 24 illustrates an embodiment featuring an opening adjacent to the bottom surface of the electronic device enclosed within. The case includes at least one button configured to transfer motion for operating the electronic device. Reference numeral 2405 denotes at least one outer layer. Reference numeral 2431 represents a secondary outer layer that forms a first peripheral wall surrounding the electronic device, and further includes a stepped wall structure comprising a second, higher step configured to provide protection to elevated surfaces of the electronic device, such as a camera module. The elevated structure may extend peripherally around the edges of the device and/or surround raised regions located away from the edges, including camera modules positioned at or near the center of the device's rear surface. The stepped wall configuration enables impact protection without obstructing the functional areas of the elevated component. Reference numeral 2481 indicates a layer that extends inward over the camera lenses, providing protection with an additional structure without placing any material directly over the central lens viewing surface. Reference numeral 2441 identifies an opening aligned with the speaker, charging port, or other functional interface.

Any embodiments explored here can have two layers connected directly or indirectly to provide enhanced protection. They also can be connected to one another by having a medium between them in the at least one gap between them. The connection can be detachable or permanently glued. A part of or a feature of any embodiments discussed or illustrated in any of the figure can be combined with any other embodiments discussed in this application. Each feature has own advantages thus can be combined to make a protective case with best protection or purpose possible. The gap in any of the embodiments discussed—whether located between the outer layer and the electronic device, between the inner layer and the outer layer, between the inner layer and the electronic device, or among multiple inner layers—may also be structurally optimized by incorporating variations in volume, density, geometric patterns, or reinforcement structures.

In another variation, the protective structure may include one or more small protrusions, such as pins, configured to maintain separation between the outer layer and the electronic device enclosed within. These pins or equivalent structural elements are designed to flex or deform upon impact, thereby absorbing shock and reducing the force transmitted to the electronic device during a drop event. The flexural strengths of the at least one inner layer, the at least one outer layer, the at least one channel for a speaker, the at least one camera lens protector, the at least one first inner layer, the at least one secondary inner layer, or any other layer incorporated in the construction of the electronic device, may fall within the following ranges: 6-9 MPa, 12-18 MPa, 22-28 MPa, 32-38 MPa, 42-48 MPa, 52-58 MPa, 62-68 MPa, 72-78 MPa, 82-88 MPa, 92-108 MPa, 112-128 MPa, 132-148 MPa, 152-174 MPa, 176-198 MPa, 200 MPa or greater. Any of the embodiments discussed previously can have the inner layer keeps an inner surface of the outer layer at least 0.5 mm or 1 mm away from the electronic device.

The flexural modulus of the at least one inner layer, the at least one outer layer, the at least one channel for a speaker, the at least one camera lens protector, the at least one first inner layer, the at least one secondary inner layer, or any other layer incorporated in the construction of the electronic device, may fall within the following ranges: 6-50 MPa, 50-100 MPa, 100-200 MPa, 200-400 MPa, 400-800 MPa, 800-1500 MPa, 1500-2500 MPa 2500-5000 MPa, 1000-10000 MPa, 10000-20000 MPa, 20000-40000 MPa, 40000-80000 MPa, 80000-160000 MPa, 160000 MPa or greater. Any of the embodiments discussed previously can have the inner layer keeps an inner surface of the outer layer at least 0.5 mm or 1 mm away from the electronic device.

Elongation at break % should be less than 175-200, 150-174, 125-149, 100-124, 60-99, 30-59, 2-29, 0-2.
Shock Absorption by Sliding and Bending, with Minimal Compression: Unlike conventional soft-material cases (e.g., silicone) that primarily rely on squeezing or compression to absorb impact, this design emphasizes shock absorption through sliding and bending of structured layers.
Minimal Squeezing of Material: Impact forces are managed through controlled flexure (bending) and layer displacement (sliding), significantly reducing the need for thick, compressible materials.
Greater Rigidity with Thinner Layers: The combination of material selection and structural configuration allows for a more rigid construction that still provides effective shock absorption, enabling the use of thinner layers without sacrificing protection.
Reduced Size and Weight: The case delivers superior impact protection while remaining substantially thinner and lighter than traditional cases made from soft, bulky materials.
Functional Efficiency Through Structure, Not Just Material: The design achieves high performance not by relying on ultra-soft materials, but by engineering the mechanical behavior of the layers themselves—such as bending and sliding—to absorb shock. Unlike conventional cases that use soft materials, which tend to be heavy and bulky while lacking structural shape and rigidity due to their softness, this design maintains both protective performance and form stability. The protective case may be adapted for various types of portable electronic devices including vehicle key fobs, smartwatches, wireless earbud cases, GPS tracking tags, medical monitoring devices, handheld gaming controllers, or smart remote controls, VR sets wherein the shock-absorbing structure comprising inner and outer layers and defined gaps may be configured based on device geometry. In further embodiments, the protective structure may be applied to rugged communication devices used by military or police personnel, including body-worn radios, encrypted communication modules, and tactical headsets. The layered shock-absorbing case may be adapted to enclose and protect such devices from impact during field operations while preserving functionality and durability. The protective structure described herein may be adapted for a wide range of use cases beyond conventional phone or electronic device cases. Applications include portable and wearable devices such as smartphones, tablets, portable computers, vehicle key fobs, smartwatches, wireless earbud charging cases, GPS tracking tags, medical monitoring devices, handheld scanners, gaming controllers, remote controls, and virtual reality headsets. The structure is also suitable for ruggedized communication devices used in military and law enforcement, including body-worn radios, encrypted communication modules, and tactical headsets. Additionally, the invention may be applied to protective gear such as helmets, safety vests, and body armor, where the layered, gap-based system can provide impact resistance while maintaining structural stability and user mobility.

1. A protective case for a protected object, the case comprising: at least one inner layer, at least one gap, and at least one outer layer;
wherein the at least one inner layer is composed of a material having a yield strength greater than 12 MPa and an elongation at break below 511%; wherein the at least one inner layer protrudes from the at least one outer layer, thereby forming the at least one gap, the at least one gap being: a) between the at least one outer layer and the at least one inner layer, b) between the at least one inner layer and the protected object, or c) both a) and b);
wherein the at least one gap provides space for the at least one inner layer to bend temporarily in response to an external force, thereby forming a squeezable space that contributes to shock absorption and protects the protected object enclosed therein.

2. The protective case of claim 1, wherein the at least one gap is structurally optimized, comprising variations in volume density, patterns, or reinforcements, and wherein the gap is optionally partially or fully filled with a material configured to influence shock absorption characteristics.

3. The protective case of claim 1, wherein at least a portion of the at least one inner layer overhangs relative to the at least one outer layer, forming a void that extends horizontally, vertically, or diagonally, such that the void provides additional space for the inner layer to flex or compress during impact.

4. The protective case of claim 1, wherein a maximum thickness of the at least one gap is greater than a minimum thickness of at least one of the at least one inner layer or the at least one outer layer, or wherein the protective case comprises a secondary material having a yield strength greater than 7 MPa.

5. The protective case of claim 1, wherein the protective case comprises two or more of the at least one inner layer, wherein at least one of the inner layers is configured to bend elastically and to slide in at least one direction under mechanical stress, such that the combination of the two or more inner layers enhances the shock absorption performance of the protective case.

6. The protective case of claim 1, wherein the protected object is selected from the group consisting of a smartphone, a vehicle key fob, a smartwatch, a wireless earbud charging case, a GPS tracking tag, a handheld medical monitoring device, a handheld gaming controller, a smart home remote control, a virtual reality headset, a tablet, a portable computer, a handheld scanning device, a helmet, a protective body gear article including a safety vest used in military or law enforcement applications, and a military or police communication electronic device.

7. A non-transitory computer-readable medium having stored thereon executable instructions configured to be used by a digital distribution platform to facilitate the distribution, sharing, or sale of a non-transitory computer-readable three-dimensional model of at least the at least one inner layer of the protective case of claim 1.

8. The protective case of claim 1, wherein at least the at least one inner layer is fabricated by a 3D printing apparatus based on a non-transitory computer-readable model of the protective case.

9. A protective case for a protected object, the case comprising: at least one inner layer, at least one outer layer, and at least one gap;
wherein the at least one inner layer is composed of a material having a yield strength greater than 12 MPa and an elongation at break below 511%; wherein the at least one gap is: a) between the at least one outer layer and the at least one inner layer, b) between the at least one inner layer and the protected object, or c) both a) and b);
wherein the at least one gap provides space for the at least one inner layer to bend temporarily in response to an external force, thereby forming a squeezable space that contributes to shock absorption and protects the protected object enclosed therein.

10. The protective case of claim 9, wherein the at least one gap is structurally optimized, comprising variations in volume density, patterns, or reinforcements, and wherein the gap is optionally partially or fully filled with a material configured to influence shock absorption characteristics.

11. The protective case of claim 9, wherein the at least one inner layer includes a wavy structure comprising alternating peaks and valleys, the wavy structure being configured to flatten under impact, thereby enhancing shock absorption through geometric deformation.

12. The protective case of claim 9, wherein a maximum thickness of the at least one gap is greater than a minimum thickness of at least one of the at least one inner layer or the at least one outer layer, or wherein the protective case comprises a secondary material having a yield strength greater than 7 MPa.

13. The protective case of claim 9, wherein the protective case comprises two or more of the at least one inner layer, wherein at least one of the inner layers is configured to bend elastically and to slide in at least one direction under mechanical stress, such that the combination of the two or more inner layers enhances the shock absorption performance of the protective case.

14. The protective case of claim 9, wherein the protected object is selected from the group consisting of a smartphone, a vehicle key fob, a smartwatch, a wireless earbud charging case, a GPS tracking tag, a handheld medical monitoring device, a handheld gaming controller, a smart home remote control, a virtual reality headset, a tablet, a portable computer, a handheld scanning device, a helmet, a protective body gear article including a safety vest used in military or law enforcement applications, and a military or police communication electronic device.

15. A non-transitory computer-readable medium having stored thereon executable instructions configured to be used by a digital distribution platform to facilitate the distribution, sharing, or sale of a non-transitory computer-readable three-dimensional model of at least the at least one inner layer of the protective case of claim 9.

16. The protective case of claim 9, wherein at least the at least one inner layer is fabricated by a 3D printing apparatus based on a non-transitory computer-readable model of the protective case.

17. A protective case for a protected object, the case comprising: at least one outer layer and at least one gap;
wherein the at least one outer layer is composed of a material having a yield strength greater than 12 MPa and an elongation at break below 511%; wherein the at least one gap is defined between the at least one outer layer and the protected object enclosed therein;
wherein the at least one gap provides space for the at least one outer layer to bend temporarily in response to an external force, thereby allowing the protected object to move at least partially into the at least one gap; wherein such movement contributes to shock absorption and protects the protected object from impact.

18. The protective case of claim 17, wherein the at least one outer layer comprises regions of varying thickness to enhance localized flexibility near the at least one gap.

19. The protective case of claim 17, wherein the at least one gap has a width of at least 0.5 millimeters.

20. The protective case of claim 17, wherein the protected object is selected from the group consisting of a smartphone, a vehicle key fob, a smartwatch, a wireless earbud charging case, a GPS tracking tag, a handheld medical monitoring device, a handheld gaming controller, a smart home remote control, a virtual reality headset, a tablet, a portable computer, a handheld scanning device, a helmet, a protective body gear article including a safety vest used in military or law enforcement applications, and a military or police communication electronic device.
